(19) United States
(12) Patent Application Publication
(10) Pub. No.: US 2005/0235863 A1
(43) Pub. Date: Oct. 27, 2005

(54) Auto igniting pyrotechnic booster

(76) Inventor: Bruce A. Stevens, Oakland, MI (US)

Correspondence Address: L. C. Begin & Associates, PLLC, PMB 403, 510 Highland Ave., Milford, MI, 48381, US

(21) Appl. No.: 11/048,655

(22) Filed: Jan. 28, 2005

Related U.S. Application Data
(60) Provisional application No. 60/540,163, filed on Jan. 29, 2004.
(60) Provisional application No. 60/539,798, filed on Jan. 28, 2004.

(51) Int. Cl. C06D 5/00; B60R 21/28

(52) U.S. Cl. 102/531; 280/741

(57) ABSTRACT

The present invention generally relates to auto-ignition/booster compositions for inflators of occupant restraint systems, for example. An auto-ignition/booster composition in accordance with the present invention includes an auto-ignition composition combined with silicone. When uncured silicone is added to a mixture of the dry granulated constituents of both the auto-ignition and booster components, an extrudable or thixotropic mixture is produced. The uncured mixture may then be applied to any desired surface within an associated gas generator within a vehicle occupant protection system, for example, thereby simplifying gas generator manufacture. A gas generating system incorporating the present composition is also contemplated.

### CROSS REFERENCE TO RELATED APPLICATIONS

This application claims the benefit of U.S. Provisional Application Ser. No. 60/540,163 filed on Jan. 29, 2004, and of U.S. Provisional Application Ser. No. 60/539,798 filed on Jan. 28, 2004.

### BACKGROUND OF THE INVENTION

Auto-ignition materials in automotive air bag inflators allow the device to safely deploy in the event of a fire. By including an auto-ignition composition the likelihood of a safety hazard resulting from the bursting of an inflator is substantially reduced.

On the other hand, pyrotechnic booster compositions raise the operating pressure of a pressure vessel or inflator prior to ignition of the main or primary gas generant. As a result, ready ignition of the primary gas generant is facilitated along with sustained combustion thereof.

Accordingly, most inflators or gas generators for vehicle occupant protection systems, for example, typically include an auto-ignition composition juxtaposed next to a discrete booster composition. In the event of a fire, the auto-ignition composition ignites to thereby ignite the booster composition which thereby ignites the main gas generant. As such, the fire hazard is substantially mitigated.

An ongoing challenge is to continue simplification of gas generator manufacturing processes thereby resulting in lower overall costs. As such, combining the auto-ignition and booster compositions into one composition would simplify the manufacture and assembly of a gas generator, one employed in a vehicle occupant protection system for example.

### SUMMARY

A pyrotechnic formulation comprising an auto-ignition composition (e.g. a fuel and an oxidizer such as d-glucose and potassium chlorate) and silicone that self-ignites at a specific design temperature or temperature range. The pyrotechnic also serves as a booster for pyrotechnic gas generators used as automotive gas generators or air bag inflators. Accordingly, the present compositions may function both as an auto-ignition pyrotechnic and as a booster charge pyrotechnic thereby eliminating the need for two separate compositions in the inflator.

Furthermore, the booster composition also propagates ignition of the main gas generation through flame and/or heat propagation. The sequence of events for the auto-ignition of an inflator includes the ignition of the auto-ignition material, which subsequently ignites the booster material, which in turn ignites the main gas generating pyrotechnic. This invention eliminates the need for individual auto-ignition and booster pyrotechnics, and replaces them with one single pyrotechnic component, greatly simplifying the inflator design, and improving inflator performance.

By integrating the auto-ignition and booster compounds into one composition, the single auto-ignition/booster composition may be extruded upon any surface juxtaposed to a primary gas generant bed, thereby providing thermodynamic communication between the auto-ignition/booster and the main propellant. Accordingly, the design provides greater conduction of heat to the primary gas generant of the inflator thereby enhancing auto-ignition function in case of a fire. The present single auto-ignition/booster composition also facilitates simplicity of the inflator design.

### BRIEF DESCRIPTION OF THE DRAWINGS

FIG. 1 is a cross-sectional view of an inflator assembly in accordance with the present invention; and

FIG. 2 is a schematic view of a gas generating system and a vehicle occupant restraint system incorporating the composition of the present invention.

### DETAILED DESCRIPTION OF THE PREFERRED EMBODIMENT

The present invention includes an auto-ignition component and a booster component combined to form a substantially uniform mixture. The auto-ignition component may be any known auto-ignition component such as the combination of d-glucose and potassium chlorate, or nitrocellulose. A booster component may be formed from silicone at about 10-30 weight percent of the total composition when combined with the auto-ignition component, and an oxidizer such as potassium perchlorate. Other constituents of the booster component may be formed from known gas generant compositions so long as silicone is also included therein.

A preferred auto-ignition component of the present invention includes a fuel and an oxidizer that self-ignites at a specific temperature, particularly at a temperature less than or equal to 250° C. A fuel is preferably selected from sugars such as d-glucose, maltose, fructose, and sucrose, and organic acids such as tartaric acid at about 15-45 weight percent of the composition. Exemplary organic acids include the various enantiomers of tartaric acid, malic acid, succinic acid, diglycolic acid, malonic acid, trans-glutaconic acid, adipic acid, mucic acid, 2,2-Bis(hydroxymethyl) propionic acid, citric acid, phenylmalonic acid, and quinic acid. Exemplary enantiomers of this group include D-tartaric acid, DL-tartaric acid, Meso-tartaric acid, D-glutamic acid, and D-quinic acid. The organic acid should preferably have a melting point ranging from about 125 to about 250° C. and pass a heat aging test at 107° C. for 400 hours. The auto-ignition temperature of the fuel is preferably about 250 to 110° C. as determined by differential scanning calorimetry/thermogravimetric analysis (DSC/TGA).

An auto-ignition component oxidizer contains a metal chlorate salt at about 55-85 weight percent of the auto-ignition composition, preferably potassium chlorate. The metal chlorate salt may be selected from the group including alkali, alkaline earth, and transitional metal chlorates, and mixtures thereof.

In accordance with the present invention, the auto-ignition oxidizer and the auto-ignition fuel are preferably dry-mixed or otherwise combined into a substantially homogeneous auto-ignition composition, pelletized, and then crushed and granulated to form substantially homogeneous granules of the auto-ignition composition for mixture in the present compositions.

The compositions of the present invention include any auto-ignition composition known in the art and silicone at about 10-35 weight percent. The oxidizer included in the auto-ignition composition, such as potassium chlorate, when provided in sufficient oxidizing quantities, may also function to oxidize the silicone as well as the auto-ignition fuel, thereby providing a booster function within an inflator, for example. A preferred auto-ignition/booster composition includes a granulated auto-ignition composition, a fuel/binder formed from silicone at 10-35% by weight of the total composition, and a booster oxidizer (preferably potassium perchlorate) at about 35-55 weight percent of the total composition.

The term “silicone” as used herein will be understood in its generic sense. Hawley describes silicone (organosiloxane) as any of a large group of siloxane polymers based on a structure consisting of alternate silicon and oxygen atoms with various organic radicals attached to the silicon: 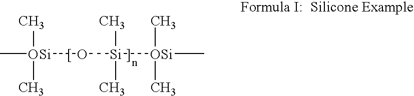
Or, silicone can be more generically represented as shown in Formula 2 (but not thereby limited): 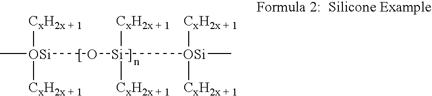
Note, “n” in the Formulas indicates a multiple of the polymeric group or portion of the molecule given within the brackets, to include the organic groups attached to the silicon. Certain benefits realized by the use of silicone in the present compositions include: the booster function within an auto-ignition composition; the formation of a compressible elastic structure when the silicone is cured thereby facilitating ease of positioning and retention within the inflator assembly and ensuring intimate thermal contact with the outer surface of the inflator; an extrudable thixotropic composition when the silicone is uncured thereby facilitating ease of insertion within the inflator assembly; and ease of ignition of the primary gas generant from the auto-ignition input, and from a relatively hot combustion temperature from combustion of the silicone/oxidizer composition.

Exemplary silicones include those disclosed in U.S. Pat. Nos. 5,589,662, 5,610,444, and 5,700,532, and, in TECHNOLOGY OF POLYMER COMPOUNDS AND ENERGETIC MATERIALS, Fraunhofer-Institut fur Chemische Technologie (ICT), 1990, each reference and document herein incorporated by reference. Silicone may be provided by any known supplier such as Shin-Etsu Silicones of America, Inc. of Akron, Ohio. It will be appreciated that curing and addition of the silicone is done in accordance with manufacturer instructions.

A preferred auto-ignition/booster composition contains by weight percent of the composition silicone at about 25%, auto-ignition granules at about 35%, and potassium perchlorate at about 40%. As known in the art, the various constituents of the present compositions may be granulated in relatively smaller particle sizes by a ball mill, vibrator mill, fluid energy mill, or hammer mill.

A booster component of the present invention therefore contains silicone and if required, a booster oxidizer. It should be appreciated that the auto-ignition oxidizer, potassium chlorate for example, may be provided in quantities and granular sizes sufficient to oxidizer both the auto-ignition and booster fuel components. In general, many known gas generant compositions, for use within vehicle occupant protection systems for example, may be employed in addition to silicone and any booster oxidizer, as secondary booster components of the present compositions. Known gas generant compositions as described in U.S. Pat. Nos. 5,035,757, 6,210,505, 6,287,400, 6,074,502, 5,872,329, 5,756,929, and 5,531,941, all incorporated by reference, exemplify booster gas generants that function to raise the pressure of an associated pressure vessel, thereby propagating combustion of a primary gas generant bed.

In addition to silicone as a primary booster fuel, the secondary booster fuel may be selected from the group of fuels including nitrogen-containing fuels, guanidines, aminoguanidines, tetrazoles, triazoles, metal and nonmetal salts of tetrazoles and triazoles, and mixtures thereof. The booster component oxidizer may therefore when desired be selected from metal and nonmetal salts of chlorates, perchlorates, nitrates, nitrites, permanganates, oxides, and mixtures thereof. The metal salts may be selected from alkali, alkaline earth, and transitional metal salts, and mixtures thereof. The secondary booster fuel is provided at about 0-25 weight percent of the booster component. The booster oxidizer represents 0-75 weight percent of the booster component. A preferred oxidizer is potassium perchlorate. It has been observed that the use of silicone with any auto-ignition composition may provide the same benefit, that is auto-ignition and booster functionality, while still providing the manufacturing advantages described below.

The auto-ignition composition including the fuel and oxidizer is provided at about 20-50 weight percent of the total composition whereas the booster composition containing all required and optional constituents is provided at about 50-80 weight percent. When formulating the auto-ignition compositions of the present invention, each constituent is first granulated when provided as a solid. As such, the auto-ignition component may be formed by mixing granulated potassium chlorate with a granulated sugar and/or granulated organic acid. A planetary mixer may be employed to provide uniform or substantially homogeneous mixtures of the various granules. It will be appreciated that tailoring of the burn rates or ballistic properties may be accomplished through iteratively determining the desired average granular size for each constituent. When employing secondary booster components, any other constituents known for their utility in auto-ignition/gas generant compositions may also be incorporated into the auto-ignition component in granulated form. As such, ballistic modifiers, coolants, and other useful additives could also be provided in known effective amounts or in known effective weight percents.

The booster component may be formulated in the same way and therefore a pelletized gas generant containing a fuel and an oxidizer may be granulated and then mixed as described above. Again, other constituents known for their utility in auto-ignition/gas generant compositions such as ballistic modifiers and coolants may also be provided in known effective amounts or in known effective weight percents. The gas generant constituents of the present invention may be supplied by well known suppliers such as Aldrich Chemical Company of Milwaukee, Wis.

Once the auto-ignition component is formulated, the auto-ignition and booster components may be mixed together to result in substantially uniform or homogeneous extrudable thixotropic mixtures. The uncured mixture may then be applied to any desired surface within an associated gas generator within a vehicle occupant protection system, for example, thereby simplifying gas generator manufacture. Once cured, the mixture forms an elastic compressible solid.

Typical inflator assembly methods require the formation of an auto-ignition repository within the inflator structure. Auto-ignition tablets may then be placed within the repository and sealed or enclosed within the repository with a taped seal. A booster composition may then be placed proximate to the auto-ignition composition thereby facilitating thermodynamic communication between the two compositions upon auto-ignition of the auto-ignition composition.

In contrast, a pellet of cured booster/auto-ignition material may be positioned in the inflator assembly such that it is wedged or compressed into place whereby a first surface of the material is in intimate contact with an exterior component or housing of the inflator. Accordingly, the inflator assembly can be designed such that no additional features or components are required to keep the booster/auto-ignition material in position.

It will also be appreciated that an uncured extrudable auto-ignition/booster mixture may be applied directly to a desired surface that interfaces with the primary gas generant and thermodynamically communicates with the outside of the inflator. The mixture may then be cured thereafter in accordance with manufacturer instructions. As such, the surface area of the auto-ignition composition in contact with the desired surface may be increased and/or optimized to provide a more effective interface to increase and/or tailor thermodynamic communication with the primary gas generant chamber. When compared to typical inflator assembly, the present auto-ignition/booster compositions provide an improved method of assembly thereby resulting in ease of assembly and reduced manufacturing costs, and also resulting in improved performance predictability.

Accordingly, in yet another aspect of the invention, an inflator manufacturing method and a gas generating system is provided wherein the gas generating system includes an inflator formed from a manufacturing method including the following steps:
1. combining a granulated auto-ignition composition with uncured silicone to form an auto-ignition/booster composition wherein the silicone is provided at about 10-35 wt % of the total composition;
2. providing an inflator having a surface for receipt of the auto-ignition/booster composition wherein the surface provides thermodynamic communication between the auto-ignition/booster composition and a primary gas generant composition within the inflator; and
3. extruding the auto-ignition/booster composition containing the uncured silicone onto the surface.

All other aspects of inflator manufacture may be accommodated as known in the art and as exemplified in the inflator references discussed below and incorporated herein by reference. Accordingly, components such as the inflator housing, igniter, filter, gas generant compositions, and other typical inflator components may all be manufactured, formed, supplied, and assembled in manners known in the art. The noteworthy benefit in the present manufacturing method is the ability to extrude auto-ignition/booster compositions in one step by virtue of the use of uncured silicone therein.

In contrast, in many known manufacturing methods, placement of a discrete auto-ignition composition and placement of a discrete booster composition within the inflator consists of at least two separate steps, and each composition must be contained within a respective repository or cavity. The compositions of the present invention, when extruded in an uncured state, may then be later cured as per silicone manufacturer directions. Roughening the surface to receive the auto-ignition/booster composition, prior to extrusion of the auto-ignition/booster composition thereon, may simplify and/or facilitate deposition of the auto-ignition/booster composition on the desired surface. The surface may be any surface that is conveniently located within the inflator, on a surface that may exist for other structural reasons, for example. Accordingly, an exemplary surface might exist upon a chamber divider within the inflator, or, it might exist upon an igniter support tube within the inflator. Other typical inflator surfaces might also accommodate placement of the auto-ignition/booster composition extrusion so long as the surface provides thermodynamic communication between the auto-ignition/booster composition and a primary gas generant composition.

Compositions formulated in accordance with the present invention preferably auto-ignite at about 250 degrees Celsius or less, function as a booster charge, and inhibit the production of noxious gases. In essence, the compositions of the present invention burn relatively hotter and therefore the gas pressure is increased. Accordingly, less gas is needed to pressurize the combustion chamber. Unlike certain known auto-ignition compositions, many compositions of the present invention also survive standard heat aging testing at 107 degrees Celsius for 400 hours.

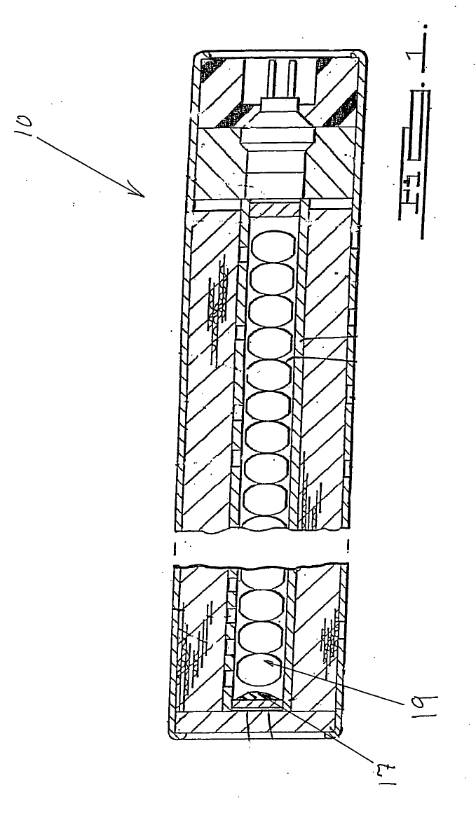

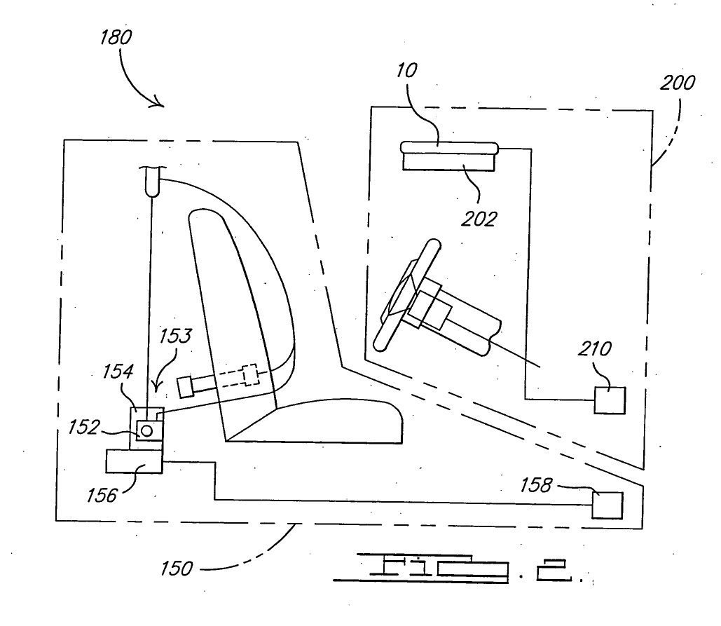

As shown in FIG. 1, an inflator incorporating any of the compositions described above may be incorporated into a gas generating system 200, as exemplified in FIG. 2. Gas generating system 200 includes at least one airbag 202 and an airbag inflator 15 coupled to airbag 202 so as to enable fluid communication with an interior of the airbag for inflating the airbag in the event of a collision. Examples of inflators which may be incorporated into gas generating system 200 are described in U.S. Pat. Nos. 6,764,096, 6,659,500, 6,422,601, 6,752,421 and 5,806,888, each incorporated herein by reference. The inflator includes an embodiment of composition 17 as described above for use within the inflator. As shown within the inflator 10, the composition 17 thermodynamically communicates with an exterior of the inflator 17 and upon auto-ignition will fluidly communicate with the primary gas generant 19. It should be appreciated that the composition 17 as shown represents an extruded mixture subsequently cured within the inflator 10, or, in the alternative, a cured compressible composition 17 placed within the inflator 10 and compressed or impinged within the structure shown. Gas generating system 200 may also be in communication with a crash event sensor 210 including a known crash sensor algorithm that signals actuation of airbag system 200 via, for example, activation of airbag inflator 15 in the event of a collision.

Referring to FIG. 2, gas generating system 200 may also be incorporated into a broader, more comprehensive vehicle occupant restraint system 180 including additional elements such as a safety belt assembly 150. FIG. 2 illustrates a schematic diagram of one exemplary embodiment of such a restraint system.

Safety belt assembly 150 includes a safety belt housing 152 and a safety belt 100 in accordance with the present invention extending from housing 152. A safety belt retractor mechanism 154 (for example, a spring-loaded mechanism) may be coupled to an end portion 153 of the belt. In addition, a safety belt pretensioner 156 may be coupled to belt retractor mechanism 154 to actuate the retractor mechanism in the event of a collision. Typical seat belt retractor mechanisms which may be used in conjunction with the safety belt embodiments of the present invention are described in U.S. Pat. Nos. 5,743,480, 5,553,803, 5,667,161, 5,451,008, 4,558,832, and 4,597,546, incorporated herein by reference. Illustrative examples of typical pretensioners with which the safety belt embodiments of the present invention may be combined are described in U.S. Pat. Nos. 6,505,790 and 6,419,177, incorporated herein by reference.

Safety belt system 150 may be in communication with a crash event sensor 158 (for example, an inertia sensor or an accelerometer) including a known crash sensor algorithm that signals actuation of belt pretensioner 156 via, for example, activation of a pyrotechnic igniter (not shown) incorporated into the pretensioner. U.S. Pat. Nos. 6,505,790 and 6,419,177, previously incorporated herein by reference, provide illustrative examples of pretensioners actuated in such a manner. Again, composition 17 may also be employed within a micro gas generator formed in a known manner within pretensioner 156.

It will be understood that the foregoing description of an embodiment of the present invention is for illustrative purposes only. As such, the features herein disclosed are susceptible to a number of modifications commensurate with the abilities of one of ordinary skill in the art, none of which departs from the scope of the present invention as defined in the appended claims.

1. A gas generating system comprising a composition, the composition comprising:
an auto-ignition component having an auto-ignition temperature equal to or less than 250° C.; and
a booster component comprising silicone at about 10-30 weight percent of the total composition.

2. The gas generating system of claim 1 further comprising an inflator containing said composition, wherein said composition functions as an auto-ignition and booster compound.

3. A gas generating system comprising an inflator formed from a method of manufacturing an inflator, the method comprising the steps of:
combining a granulated auto-ignition composition with uncured silicone to form an auto-ignition/booster composition wherein the silicone is provided at about 10-35 wt % of the total composition;
providing an inflator having a surface for receipt of the auto-ignition/booster composition wherein the surface provides thermodynamic communication between the auto-ignition/booster composition and an exterior of the inflator, and fluid communication with a primary gas generant composition within the inflator; and
extruding the auto-ignition/booster composition containing the uncured silicone onto the surface.

4. A method of manufacturing an inflator, the method comprising the steps of:
combining a granulated auto-ignition composition with uncured silicone to form an auto-ignition/booster composition wherein the silicone is provided at about 10-35 wt % of the total composition;
providing an inflator having a surface for receipt of the auto-ignition/booster composition wherein the surface provides thermodynamic communication between the auto-ignition/booster composition and an exterior of the inflator, and fluid communication with a primary gas generant composition within the inflator; and
extruding the auto-ignition/booster composition containing the uncured silicone onto the surface.
